(19) United States
(12) Patent Application Publication
(10) Pub. No.: US 2003/0168081 A1
(43) Pub. Date: Sep. 11, 2003

(54) Motor-driven, portable, adjustable spray system for cleaning hard surfaces

(75) Inventors: Kyu H. Lee, Gardena, CA (US); Larry W. French, Gardena, CA (US)

Correspondence Address: WILLIE KRAWITZ, 3001 CHAPEL HILL ROAD, ORANGE, CA, 92867, US

(73) Assignee: TIMBUCKTOO MFG., INC.

(21) Appl. No.: 09/947,631

(22) Filed: Sep. 6, 2001

(51) Int. Cl. B08B 3/02; B08B 7/04

(52) U.S. Cl. 134/21; 134/34; 15/322; 239/754

(57) ABSTRACT

A motor-driven, fixed or adjustable spray system is provided, in which the motor overrides and augments the natural rotational force supplied by the input water pressure through one more inclined spray nozzles, thereby increasing the strike force and efficient water impacting of the floor surface. This enhances water delivered from one or more nozzles to impact into the floor surface such as cement, tile, pebble-reinforced concrete, patio stones, linoleum and the like and thereby dislodge various contaminants compared to conventional floor cleaning systems. The spray system may be adjustable from about horizontal to vertical and is also adapted to utilize cleaning pads such as from fibers, cloths, abrasive pads, etc. Use of the cleaning pads may also be augmented by the water spray. Rotary movement of the spray system and/or the cleaning pads may be effected by electrical power, including battery power, or by an equivalent pneumatic (i.e., air driven) power, hydraulic power, etc. For greater efficiency, material stripped from the hard surface is preferably removed through a vacuum chamber positioned around the periphery of the centrally mounted spray arrangement.

### BACKGROUND OF THE INVENTION

This invention relates to a new and improved multi-functional cleaning system with improved cleaning performance than comparable commercial devices, and which provides a wide area of cleaning coverage.

Floor and carpet cleaners are mainly single functioning devices and are described in publications such as U.S. Pat. Nos. 5,785,250; 5,890,258 both to Kyu H. Lee, one of the inventors herein; and, Des. 377,855. These devices are also described in the publications CLEANFAX MAGAZINE and SERVICES MAGAZINE. The cleaners are used for example to manually scrape and strip floors (SERVICES MAGAZINE, March, 2001, page 31); for carpet cleaning (CLEANFAX MAGAZINE, March 2001, page 19); and, for cleaning and polishing floors (CLEANFAX MAGAZINE, March 2001, front cover).

Many of these devices, particularly carpet and floor cleaners employ a hand tool attached to the device which vacuums dirt and dirty water from a cleaning area during a cleaning operation. Other devices utilize removal through multiple vacuum outlets defined by centrally disposed, fixed slots or ports adjacent the rotary components of the cleaning equipment (SERVICES MAGAZINE, March 2001, Page 16). However, this arrangement reduces spray efficiencies since the vacuum outlet slots are located close to the actual input jets of spray.

It would be desireable to provide a cleaning device for hard surfaces (such as floors and walls) with either a fixed or adjustable spray capability from about horizontal to vertical. This would provide a spray capability at both low and high angles which in turn would provide a strike pattern akin to a spray knife effect when used at high angles, and the usual cleaning capability when used at low angles.

Also, it would be desireable to provide a vacuum removal system for debris and used cleaning solution which is positioned outside the spraying area, thereby improving spraying efficiencies compared to vacuum systems which are located immediately adjacent to the spraying outlets and result in reducing spray efficiencies of these commercial devices.

Additionally, it would be desireable to provide a spray cleaning device which operates at a lower power compared to prior art devices and with an operational capability over a wide coverage area.

### THE INVENTION

According to the invention, there is provided a spray cleaning device for hard surfaces such as cement, tile, cement reinforced with pebbles, patio stones, exterior and interior surfaces, including walls or floors constructed of stone, etc.

The spray device of this invention can be used in a variety of elevations varying from about horizontal to about vertical, thereby enabling a wide range of water spray strike angles from about horizontal to about vertical. For horizontal usage, this results in an enlarged spray pattern, while the nearly vertical usage produces a spray pattern which can function similarly to that of a forward moving water knife.

Insofar as rotation of the spraying outlets is concerned, since the motor drive is set to override and augment rotation of the spray nozzles, spray coverage can be equivalent to the large coverage area of present commercial devices to coverage over a smaller area, such as within the perimeter of the spray housing This in turn enables a more concentrated application of water and cleaning solution to be applied to a given area.

When employed with adjustability of one or more nozzles, a given area may be cleaned with a regular application of water and cleaning solution, or a more concentrated application may be applied to a heavily trafficked area. In the latter case, when providing vertical adjustability to the spray nozzle head outlets, an improved cleaning function is achieved since hard to clean surface areas are more easily cleaned since the vertically inclined spray operates over a small area strike surface, and the spray is similar to a forward water moving knife.

Typically, the diameter of a useful size range of one or more chambers is about 1-120 inches; the sprayer rotation varies from about 10-10,000 rpm, and usually about 2,000 rpm; and, water pressure varies from about 1 psi to 10,000 psi. In effect the device of this invention provides a system with lower energy and lower water volume requirements, compared to commercial devices.

### BRIEF DESCRIPTION OF THE DRAWINGS

FIG. 1 is a front elevation view, partly in section and partly in perspective showing the device of this invention;

FIG. 2 is a right side elevation view illustrating the device of this invention; and, FIG. 3 is a bottom plan view of the device taken along lines 3-3 of FIG. 1.

FIG. 4 is a bottom plan view of a floating head vacuum exhaust chamber;

FIG. 5 is a side elevation view of the floating head construction of the floating head components in the vacuum chamber;

FIG. 6 is a vector diagram of liquid flow input force and the reaction spray nozzle motion of the prior art; and.

FIG. 7 is a vector diagram of the directional forces due to the use of a motor driven spray nozzle.

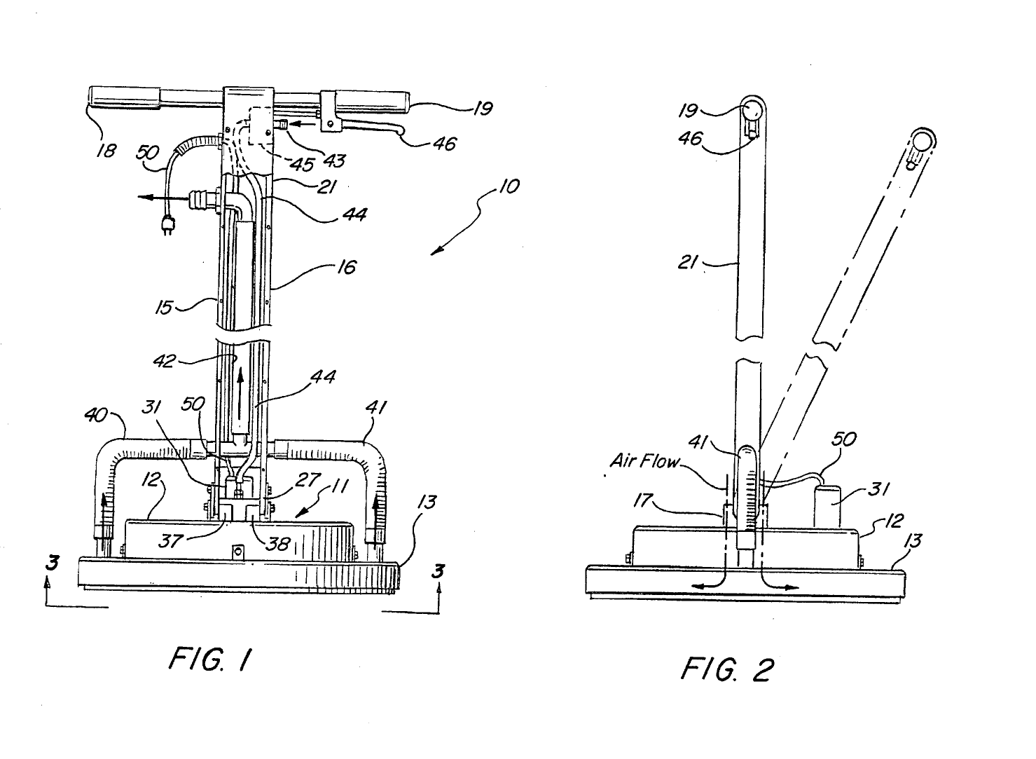

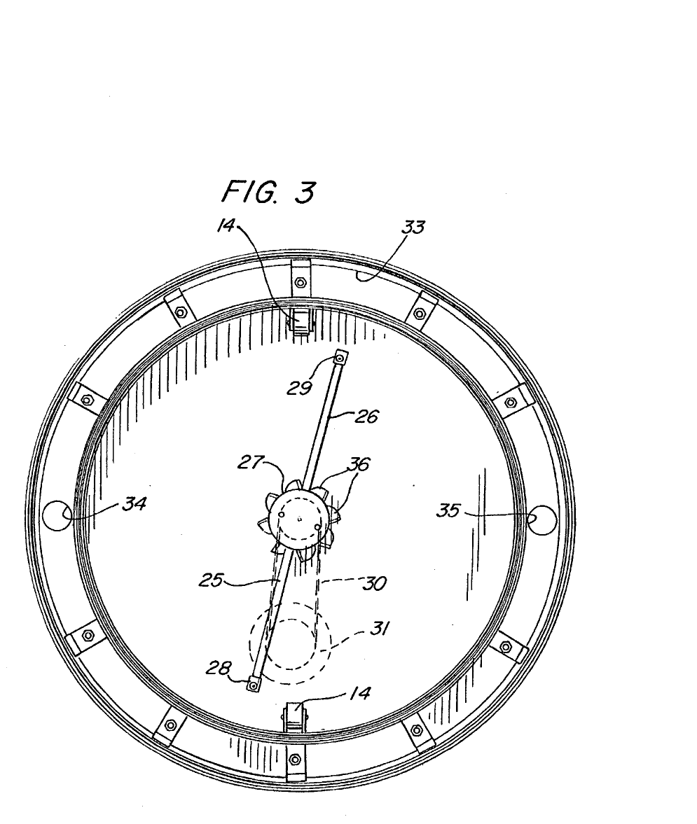

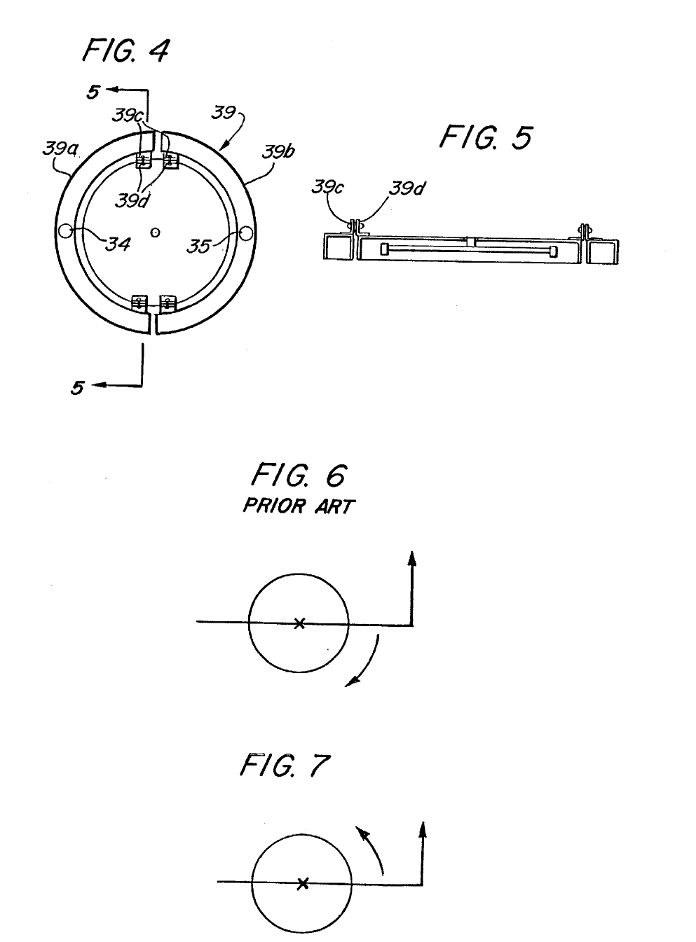

### DESCRIPTION OF THE PREFERRED EMBODIMENTS

The device 10 of this invention shown in the drawings illustrates a chamber 11 comprising a hollow, central, upper chamber 12 mounted on a lower chamber 13, the latter being adapted for close spacing with a floor surface be means of rollers 14. Split support columns 15, 16 are mounted through a central housing 17 to the upper portion of the chamber, and handles 18, 19 joined by a common bar 20 at the upper portion of the support columns are provided for moving the device. An enclosure 21 extends from the central portion of the common bar 20 down to the housing 17, and shields and secures internal components of the device, which will be described, infra.

The underside of the chamber 11 houses adjustable arms 25 and 26 mounted on a rotatable collar 27, and downwardly inclined and opposed reaction spray nozzles 28, 29 are threaded to the ends of each arm. Adjustment of the nozzles from horizontal to vertical is effected by threaded rotation of the arms and/or nozzles using an adjusting tool, as necessitated by cleaning requirements. Alternatively, the spray nozzles may be fixed medially between the horizontal and the vertical, rather than being adjustable.

The collar 27 is rotated by a belt 30 driven by a motor 31 mounted in a housing 32, the direction of the collar rotation being the same direction as the rotation of the arms 25, 26; hence, rotation of the motor will function to override and augment the direction and force of the spray. Alternatively, the motor may function in the reverse direction to rotation of the arms 25 and 26, or the motor 31 may combine both functions. When operating in the reverse direction to the arm rotation, this operational mode can function to confine the spray to a smaller cleaning area.

A circular vacuum chamber 33 is bolted or otherwise attached along the outer periphery of the lower chamber, and opposed, spaced outlet suction bores 34, 35 are defined on the vacuum chamber. If desired, a series of fan blades 36 are employed to drive air through valves 37, 38 and along the central area of the floor confined under the lower manifold 13. This action will force used water and contaminants towards the vacuum chamber and outlet bores 34 and 35, and hence improve efficiency of the device.

If desired, as shown in FIG. 5, a floating manifold 39 is shown which is split into two halves 39a and 39b, that are joined on opposed sides by overlapping, floating head support members 39c and 39d. This enables the manifold to follow an uneven floor in a more uniform manner since it can move in an articulated fashion.

As shown in FIG. 1, the outlet suction bores 34, 35 are connected by means of suction hose lines 40, 41 to a central, outlet suction hose line 42; the hose lines function to discharge used water, cleaning solution and contaminants from the floor surface.

An inlet line 43 for water and cleaning solution is connected to the reaction spray nozzles 28, 29 via a line 44, and control for supplying the inlet water and cleaning solution is provided by an inlet valve 45 which is controlled by a hand-operated lever 46. Power for the motor 31 is supplied through a power line 50 connected to the motor through the housing 32 and controlled by a power switch (not shown); alternatively, power may be supplied by battery means.

In use, water and solution are admitted through the inlet line 43 and into the arms 25, 26 and out the opposed spray nozzles 28 and 29, thereby causing the arms and attached nozzles to rotate and direct spray onto the floor at a suitable angle. As indicated, the angle of spray attack may be varied by adjusting the spray arms from about the horizontal to the vertical. In the reverse mode, when power for the motor is turned on, the motor 31 will retard and slow down the rotational speed of the arms 25 and 26 through the belt 30 and attached collar 27. If desired, this will enable the spray pattern size to be confined to the area under the manifold 13, rather than being spread out in a manner similar to that of the prior art.

As the cleaning action proceeds, suction is applied at suitable cleaning intervals, or continuously through the suction bores 34 and 35 and the hose lines 40, 41 and 42. Compressed air is driven along the fan blades 36 to drive used water along the floor surface to the suction bores and hose lines. The device of this invention is effective in saving water and power, and can be used over a wide size range and a wide range of water and power consumption.

As shown in the vector diagrams of FIGS. 6 and 7, when cleaning systems of the prior art are employed, rotation of the nozzles is counter to the applied force of the incoming commercial water supply, and this in turn reduces the force of the water being applied to the floor surface. By contrast, use of the motor driven spray nozzles of the present invention enables additional force to be imparted to the spray nozzles, thereby providing a more efficient application of cleaning solution to the floor surface.

It will be appreciated that the spray nozzles may be replaced by brushes or floor polishers, either dry or with the application of water, cleaning solution, or other ingredients such as wax.

1. A moveable device for cleaning hard surfaces, comprising: a base portion providing one or more oppositely inclined, rotatable, cleaning spray nozzles mounted along the base portion, including water supply means to rotate the spray nozzles and apply water spray and cleaning components to a floor surface, and motor drive means for the spray nozzles, the motor drive adapted to provide at least one of the following functions: overriding and augmenting directional movement of the spray nozzles; opposing movement of the spray nozzles; and, either override and augment directional movement of the spray nozzles or oppose movement of the spray nozzles, thereby improving an impact water cleaning function to the floor.

2. The device of claim 1, including a vacuum system peripherally disposed around the base portion, for removal of used water and contaminants from the floor surface.

3. The device of claim 2, comprising an articulated vacuum system.

4. The device of claim 1, in which the spray nozzles are adjustably inclined from about horizontal to vertical.

5. The device of claim 1, in which the spray nozzles are fixed in a position intermediate between horizontal and vertical.

6. The device of claim 1, comprising a directional fan providing an outward air flow to air-drive used water and contaminants away from the cleaning area.

7. The device of claim 2, in which the spray nozzles are adjustably inclined from about horizontal to vertical.

8. The device of claim 2, in which the spray nozzles are fixed from a position intermediate between horizontal and vertical.

9. The device of claim 2, comprising a fan providing a downward and outward air flow to air-drive used water and contaminants away from the cleaning area and towards the vacuum exhaust.

10. A method for cleaning a floor surface, comprising: providing a moveable base portion mounting one or more oppositely inclined spray nozzles and including water supply means for supplying water and cleaning components to the spray nozzles, and motor drive means for the spray nozzles, the method, comprising: i. rotating the nozzles with water from the water supply means; ii. applying water to the floor; and, iii. rotating the spray nozzles by means of a motor drive, rotation of the spray nozzles by the motor drive which is adapted to provide at least one of the following functions: overriding and augmenting rotation of the spray nozzles by means of the motor; opposing movement of the spray nozzles; and, combining the functions of overriding and augmenting rotation and opposing movement of the spray nozzles, thereby improving an impact water contact function with the floor surface.

11. The method of claim 10, providing a downward and outward air-flow to air-drive used water and contaminants away from the cleaning area.

12. The method of claim 10, providing a vacuum exhaust connected to the periphery of the base portion and removing used water and contaminants from the floor surface through the vacuum exhaust.

13. The method of claim 12, in which the vacuum exhaust is articulated.

14. The method of claim 10, comprising adjustably mounting the spray nozzles from about horizontal to vertical, and in the vertical position, the water functions as a water spray knife.

15. The method of claim 10, comprising fixedly mounting the spray nozzles from a position intermediate between horizontal and vertical.

16. The method of claim 10, comprising providing a fan to air-drive used water and contaminants downward and away from the cleaning area and towards the vacuum exhaust for removal from the floor surface.

17. The method of claim 10, comprising adjusting the nozzles from about horizontal to vertical, and in about the vertical position, the water functions as a water spray knife.

18. The method of claim 10, comprising fixedly mounting the nozzles to a position intermediate between horizontal and vertical.

19. The method of claim 12, comprising providing a fan to air-drive used water and contaminants away from the cleaning area and towards the vacuum exhaust for removal from the floor surface.
